(19) United States
(12) Patent Application Publication
(10) Pub. No.: US 2013/0107279 A1
(43) Pub. Date: May 2, 2013

(54) OPTICAL APPARATUS, POSITION DETECTION APPARATUS, MICROSCOPE APPARATUS, AND EXPOSURE APPARATUS

(71) Applicant: CANON KABUSHIKI KAISHA, Tokyo (JP)

(72) Inventors: Wataru Yamaguchi, Utsunomiya-shi (JP); Hideki Ina, Tokyo (JP)

(73) Assignee: CANON KABUSHIKI KAISHA, Tokyo (JP)

(21) Appl. No.: 13/648,356

(22) Filed: Oct. 10, 2012

(30) Foreign Application Priority Data
Oct. 28, 2011 (JP) 2011-237966

(51) Int. Cl. G02B 21/06; B01J 19/12; G01B 11/14

(52) U.S. Cl. 356/614; 250/492.1; 359/385

(57) ABSTRACT

The present invention provides an apparatus including an aperture stop including a first aperture configured to define an illumination condition for illuminating an illumination surface to a first condition, and a second aperture configured to define the illumination condition to a second condition, and fixed on a pupil plane of an illumination optical system, a light shielding plate, and a driving unit configured to positions the light shielding plate such that a shielding region shields a second path extending from a light source to the illumination surface through the second aperture, when setting the illumination condition to the first condition, and positions the light shielding plate such that the shielding region shields a first path extending from the light source to the illumination surface through the first aperture, when setting the illumination condition to the second condition.

### BACKGROUND OF THE INVENTION

1. Field of the Invention

The present invention relates to an optical apparatus, position detection apparatus, microscope apparatus, and exposure apparatus.

2. Description of the Related Art

Recently, the line widths of circuit patterns have become very small as the integration and micropatterning of semiconductor integrated circuits advance. In a lithography process, therefore, further micropatterning of a pattern (resist pattern) to be formed on a substrate is required. As techniques of implementing micropatterning like this, an exposure apparatus (EUV exposure apparatus) using EUV light (wavelength=10 to 15 nm) having a wavelength shorter than that of ultraviolet light and a drawing apparatus (charged particle beam drawing apparatus) that performs drawing on a substrate by using a charged particle beam are known. Note that since EUV light and a charged particle beam (electron beam) attenuate by absorption in the atmospheric environment, the EUV exposure apparatus and charged particle beam drawing apparatus are accommodated in vacuum chambers and placed in a vacuum environment at about 10⁻⁴ to 10⁻⁵ Pa or more.

In the exposure apparatus, a pattern is transferred onto a substrate by converging (focusing) exposure light to a predetermined position on the substrate. To transfer a fine pattern, therefore, it is necessary to accurately align the substrate and exposure light. When aligning the substrate and exposure light, the position of the substrate is generally detected by detecting an alignment mark on the substrate.

The detection of this alignment mark uses two kinds of modes, that is, bright field detection (bright field illumination) and dark field detection (dark field illumination), in order to accurately detect light from the mark. Bright field detection is a method of matching the numerical aperture (NA) of an illumination optical system with that of an image formation optical system, and mainly detecting the 0th-order light transmitted through the mark (object), thereby obtaining a bright field image of the mark. On the other hand, dark field detection is a method of intentionally shifting the NAs of the illumination optical system and image formation optical system from each other, and detecting the second-order light scattered or diffracted by the mark, thereby obtaining a dark field image of the mark. By detecting the alignment mark while switching bright field detection and dark field detection, it is possible to prevent a detection error and the impossibility of detection by suppressing the decrease in S/N ratio of a detection signal (alignment signal) caused by a wafer process or a step on the mark. Techniques of switching bright field detection and dark field detection are proposed in Japanese Patent Laid-Open Nos. 11-87222, 7-169429, and 2001-154103.

For example, Japanese Patent Laid-Open No. 11-87222 has disclosed a position detection apparatus for detecting an alignment mark by switching aperture stops of an illumination optical system. In this position detection apparatus, a bright field aperture stop and dark field aperture stop are switched by using a driving device such as an actuator or motor in accordance with a wafer process or a step on the mark.

Japanese Paten Laid-Open Nos. 7-169429 and 2001-154103 have disclosed microscope apparatuses for observing a sample (object) by switching bright field detection and dark field detection in accordance with the shape or structure of the sample. More specifically, Japanese Patent Laid-Open No. 7-169429 has disclosed a transmission electron microscope including a bright field detection stop and dark field detection stop on a common stop table. In this transmission electron microscope, the bright field detection stop or dark field detection stop is placed on the optical axis between a sample and transmission electron detector placed in a vacuum environment, via a driving device placed in the atmospheric environment. Also, Japanese Patent Laid-Open No. 2001-154103 has disclosed a microscope apparatus including a bright field illumination light source and dark field illumination light source, and capable of switching bright field detection and dark field detection by using these light sources.

In the EUV exposure apparatus or charged particle beam drawing apparatus, however, the position detection apparatus for aligning a substrate and exposure light or a charged particle beam is also placed in a vacuum environment, so the driving device such as an actuator or motor is used in the vacuum environment. For example, the position detection apparatus disclosed in Japanese Patent Laid-Open No. 11-87222 switches the bright field detection aperture stop and dark field detection aperture stop by using a motor, heat generation and outgas from the motor must be taken into consideration when using the motor in a vacuum environment. Therefore, a driving device such as a motor to be used in a vacuum environment must be formed by using members (materials) and adhesives that reduce the influences of heat generation and outgas. This often makes the performance lower than that of a driving device to be used in the atmospheric environment. Consequently, the driving accuracy or stroke of the driving device to be used in a vacuum environment becomes insufficient, and this makes accurate positioning of the bright field aperture stop or dark field aperture stop impossible, so the alignment mark detection accuracy sometimes decreases (a detection error sometimes occurs). Also, the manufacturing cost increases very much when the driving device to be used in a vacuum environment is so manufactured as to have the same performance as that of the driving device to be used in the atmospheric environment.

In the transmission electron microscope disclosed in Japanese Patent Laid-Open No. 7-169429, heat generation and outgas from the driving device need not be taken into account because the driving device is placed in the atmospheric environment, so a driving device to be used in the atmospheric environment can be used. Since, however, the driving device is connected to the bright field detection stop and dark field detection stop via a partition wall of a vacuum chamber, the structure of the partition wall is complicated, so the performance of the driving device is not sufficiently transmitted to the bright field detection stop and dark field detection stop. As a consequence, position control of the bright field detection stop and dark field detection stop performed by the driving device becomes insufficient. This makes it impossible to accurately position the bright field aperture stop and dark field aperture stop in a vacuum environment, and decreases the accuracy of the transmission electron microscope.

In the microscope apparatus disclosed in Japanese Patent Laid-Open No. 2001-154103, the bright field illumination light source and dark field illumination light source are arranged in a vacuum environment and switched without using any driving device such as an actuator or motor. This obviates the need to take account of heat generation and outgas from a driving device. However, when the light sources including semiconductor elements are placed in a vacuum environment, heat generation or outgas from the light sources may deform peripheral members or deposit contaminants. This decreases the accuracy of the microscope apparatus. Also, when switching bright field detection and dark field detection by switching the light sources, the structure of an optical system (that is, the apparatus) is complicated.

### SUMMARY OF THE INVENTION

The present invention provides a technique advantageous in switching illumination conditions for illuminating an illumination surface, without increasing the cost.

According to one aspect of the present invention, there is provided an optical apparatus including an illumination optical system configured to illuminate an illumination surface with light from a light source, an aperture stop including a first aperture configured to define an illumination condition for illuminating the illumination surface to a first condition, and a second aperture configured to define the illumination condition to a second condition different from the first condition, and fixed on a pupil plane of the illumination optical system, a light shielding plate including a light shielding region, and a driving unit configured to drive the light shielding plate, wherein the driving unit positions the light shielding plate such that the light shielding region shields a second path extending from the light source to the illumination surface through the second aperture, when setting the illumination condition to the first condition, and positions the light shielding plate such that the light shielding region shields a first path extending from the light source to the illumination surface through the first aperture, when setting the illumination condition to the second condition.

Further aspects of the present invention will become apparent from the following description of exemplary embodiments with reference to the attached drawings.

### BRIEF DESCRIPTION OF THE DRAWINGS

FIGS. 1A to 1D are views showing the arrangement of an illumination apparatus as an aspect of the present invention.

FIGS. 2A to 2C are views showing the arrangement of a conventional illumination apparatus.

FIG. 3 is a view showing the arrangement of a position detection apparatus as an aspect of the present invention.

FIG. 4 is a view showing the arrangement of an exposure apparatus using the position detection apparatus shown in FIG. 3.

FIG. 5 is a view showing the arrangement of a drawing apparatus using the position detection apparatus shown in FIG. 3.

FIG. 6 is a view showing the arrangement of a microscope apparatus as an aspect of the present invention.

FIGS. 7A and 7B are views each showing the arrangement of a light shielding plate as an aspect of the present invention.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

### First Embodiment

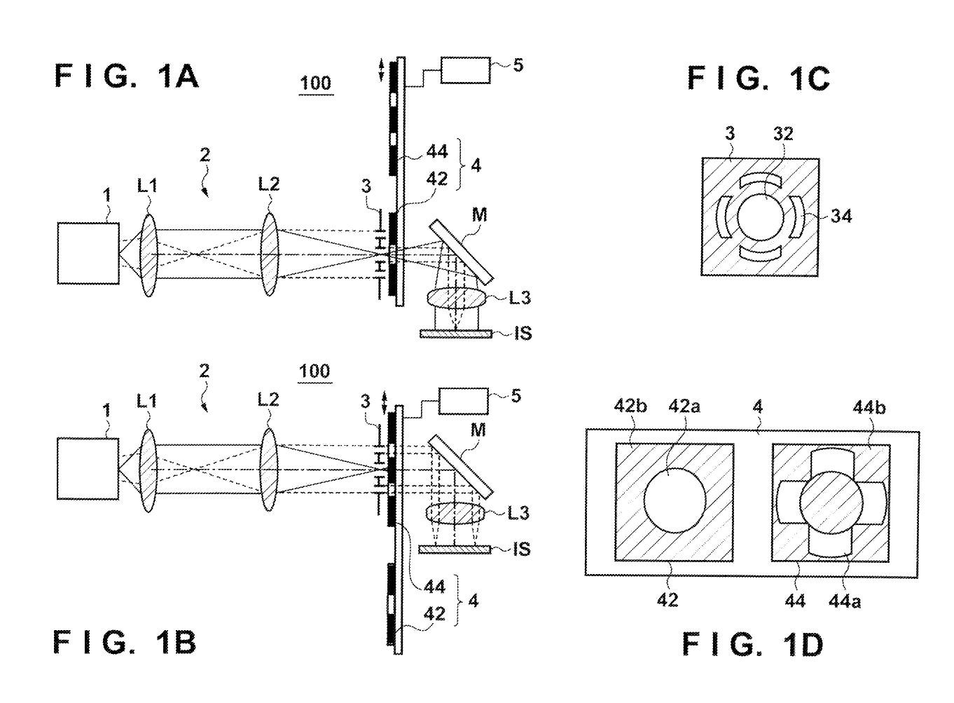

FIGS. 1A to 1D are views showing the arrangement of an illumination apparatus 100 as an aspect of the present invention. The illumination apparatus 100 is an optical apparatus that performs Koehler illumination on an illumination surface. Koehler illumination is an illumination method that illuminates an illumination surface without any illumination unevenness. However, the illumination method of the illumination apparatus 100 is not limited to Koehler illumination, and may also be, for example, critical illumination. The illumination apparatus 100 includes a light source 1, illumination optical system 2, aperture stop 3, light shielding plate 4, and driving unit 5. In this embodiment, the illumination apparatus 100 is accommodated in, for example, a vacuum chamber, and the light source 1, illumination optical system 2, aperture stop 3, light shielding plate 4, and driving unit 5 are arranged in a vacuum environment.

The illumination optical system 2 is an optical system that guides light emitted from the light source 1 to an illumination surface IS, that is, illuminates the illumination surface IS with the light from the light source 1. In this embodiment, the illumination optical system 2 includes a collector lens L1, field lens L2, mirror M, and condenser lens L3. The aperture stop 3 is fixed on the pupil plane of the illumination optical system 2 (in this embodiment, in the incident side focal position (on the incident pupil plane) of the condenser lens L3), and defines an illumination condition for illuminating the illumination surface IS. The light shielding plate 4 is placed near the pupil plane of the illumination optical system 2, and shields a part of light passed through the aperture stop 3. The driving unit 5 is formed by, for example, an actuator or motor, and drives the light shielding plate 4. In this embodiment, the driving unit 5 drives the light shielding plate 4 in a direction perpendicular to the optical axis of the illumination optical system 2. Also, the driving unit 5 is designed to be usable in a vacuum environment by using members (materials) and adhesives that reduce the influences of heat generation and outgas.

In the illumination apparatus 100, the light from the light source 1 is shaped into almost parallel light through the collector lens L1, and enters the field lens L2. The light is concentrated by the field lens L2, reflected by the mirror M, and guided to the illumination surface IS through the condenser lens L3.

The aperture stop 3 is fixed on the pupil plane of the illumination optical system 2 as described above, and hence has a conjugate positional relationship with the light source 1 in the illumination optical system 2. Therefore, the aperture stop 3 can control (change) the numerical aperture of the light concentrated by the field lens L2. Note that the numerical aperture may also be controlled by additionally arranging an iris stop near the pupil plane of the illumination optical system 2, and changing the stopping amount of the iris stop. It is also possible to limit the field of the illumination optical system 2 by arranging a field stop in a position conjugate with the illumination surface IS.

In the illumination apparatus 100, the illumination conditions are switched by using the aperture stop 3 including a bright field illumination aperture and dark field illumination aperture, and the light shielding plate 4 including aperture regions for passing light corresponding to bright field illumination and light corresponding to dark field illumination, and light shielding regions for shielding other light. FIG. 1A shows the illumination apparatus 100 in which the illumination condition is set to bright field illumination. FIG. 1B shows the illumination apparatus 100 in which the illumination condition is set to dark field illumination.

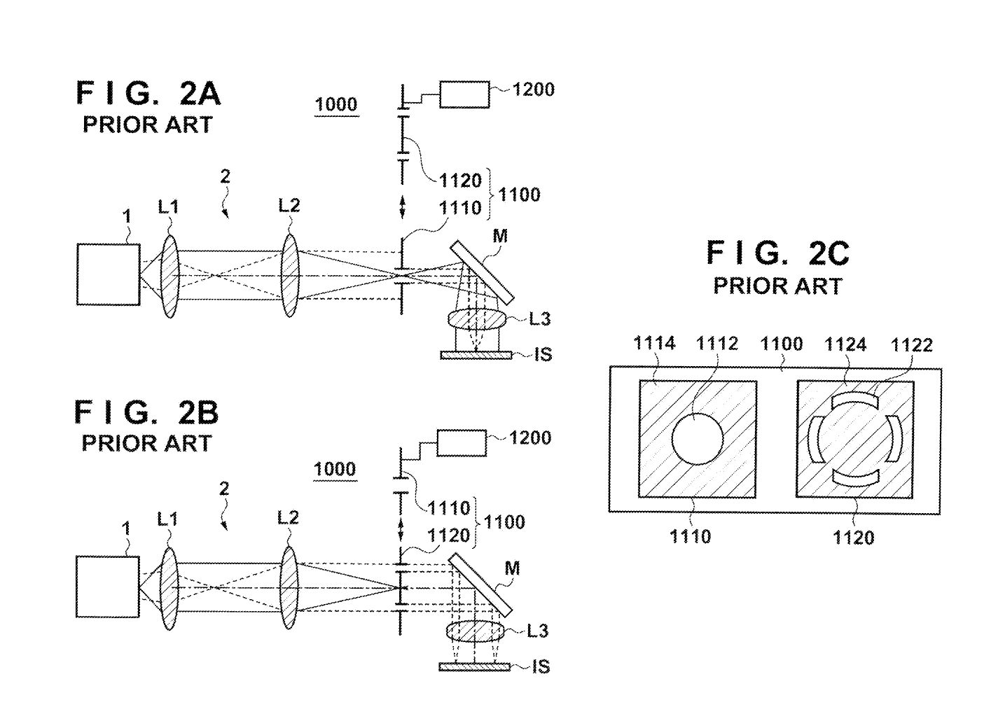

Before the explanation of details of the aperture stop 3 and light shielding plate 4, the reason why the illumination accuracy decreases when illuminating the illumination surface IS due to a positional shift of an aperture stop 1100 in a conventional illumination apparatus 1000 will be explained with reference to FIGS. 2A to 2C. FIG. 2A shows the illumination apparatus 1000 in which the illumination condition is set to bright field illumination. FIG. 2B shows the illumination apparatus 1000 in which the illumination condition is set to dark field illumination. Similar to the illumination apparatus 100, the illumination apparatus 1000 is accommodated in, for example, a vacuum chamber, and the light source 1, the illumination optical system 2, the aperture stop 1100, and a driving unit 1200 are arranged in a vacuum environment.

Compared to the illumination apparatus 100, the illumination apparatus 1000 has no light shielding plate 4 and includes the aperture stop 1100 instead of the aperture stop 3. Also, the illumination apparatus 1000 includes the driving unit 1200 for driving the aperture stop 1100, instead of the driving unit 5 for driving the light shielding plate 4. In the illumination apparatus 1000, the light from the light source 1 is guided to the illumination surface IS through the illumination optical system 2, as in the illumination apparatus 100.

When switching the illumination conditions in the illumination apparatus 1000, as shown in FIGS. 2A and 2B, the driving unit 1200 drives the aperture stop 1100, and positions a bright field illumination stop region 1110 or dark field stop region 1120 on the optical axis of the illumination optical system 2.

FIG. 2C is a view showing the arrangement of the aperture stop 1100 of the illumination apparatus 1000. The aperture stop 1100 includes the bright field stop region 1110 including an aperture portion 1112 and light shielding portion 1114 for defining the illumination condition to bright field illumination, and the dark field stop region 1120 including an aperture portion 1122 and light shielding portion 1124 for defining the illumination condition to dark field illumination. Accordingly, when the bright field stop region 1110 or dark field stop region 1120 is accurately positioned with respect to the light from the light source 1 (the optical axis of the illumination optical system 2), the illumination conditions can be switched without decreasing the illumination accuracy.

To make the driving unit 1200 usable in a vacuum environment, however, the driving unit 1200 is formed by members (materials) and adhesives that reduce the influences of heat generation and outgas. This makes it difficult to accurately drive the aperture stop 1100 when compared to the atmospheric environment. Consequently, a positional shift occurs when positioning the bright field stop region 1110 or dark field stop region 1120 with respect to the light from the light source 1, and the illumination accuracy decreases due to a shift of the numerical aperture of the light concentrated by the field lens L2.

As described above, when switching the aperture stops by using the driving unit placed in a vacuum environment, the position of the aperture stop shifts due to the performance of the driving unit, and the illumination accuracy decreases. In the illumination apparatus 100 of this embodiment, therefore, the illumination conditions are switched by using the aperture stop 3 and light shielding plate 4 as described above. More specifically, the aperture stop 3 requiring high positioning accuracy is fixed on the pupil plane of the illumination optical system 2, and the light shielding plate 4 whose required positioning accuracy is lower than that of the aperture stop 3 is driven. This makes it possible to switch the illumination conditions without decreasing the illumination accuracy.

FIG. 1C is a view showing the arrangement of the aperture stop 3. As shown in FIG. 1C, the aperture stop 3 includes a bright field aperture (first aperture) 32 for defining the illumination condition to bright field illumination (a first condition), and a dark field aperture (second aperture) 34 for defining the illumination condition to dark field illumination (a second condition different from the first condition). Also, as described previously, the aperture stop 3 is fixed on the pupil plane of the illumination optical system 2, and accurately positioned with respect to the light from the light source 1 (the optical axis of the illumination optical system 2).

FIG. 1D is a view showing the arrangement of the light shielding plate 4. As shown in FIG. 1D, the light shielding plate 4 includes a bright field region (first region) 42 and dark field region (second region) 44. The bright field region 42 includes a bright field aperture region (first aperture region) 42a and light shielding region (first light shielding region) 42b. The dark field region 44 includes a dark field aperture region (second aperture region) 44a and light shielding region (second light shielding region) 44b.

When setting the illumination condition, the driving unit 5 positions the bright field region 42 or dark field region 44 by driving the light shielding plate 4. For example, when setting the illumination condition to bright field illumination, the driving unit 5 positions the bright field region 42 with respect to the aperture stop 3. More specifically, the driving unit 5 positions the bright field region 42 so that the bright field aperture region 42a does not shield a first path extending from the light source 1 to the illumination surface IS through the bright field aperture 32, and the light shielding region 42b shields a second path extending from the light source 1 to the illumination surface IS through the dark field aperture 34. In this embodiment, the light shielding plate 4 is positioned closer to the illumination surface than the aperture stop 3. Accordingly, the bright field aperture region 42a passes light passed through the bright field aperture 32, and the light shielding region 42b shields light passed through the dark field aperture 34.

Also, when setting the illumination condition to dark field illumination, the driving unit 5 positions the dark field region 44 with respect to the aperture stop 3. More specifically, the driving unit 5 positions the dark field region 44 so that the dark field aperture region 44a does not shield the second path extending from the light source 1 to the illumination surface IS through the dark field aperture 34, and the light shielding region 44b shields the first path extending from the light source 1 to the illumination surface IS through the bright field aperture 32. In this state, the dark field aperture region 44a passes the light passed through the dark field aperture 34, and the light shielding region 44b shields the light passed through the bright field aperture 32.

In the illumination apparatus 100 of this embodiment as described above, the illumination conditions can be switched by positioning the bright field region 42 or dark field region 44 with respect to the aperture stop 3, by driving the light shielding plate 4.

The positioning accuracy of the light shielding plate 4 driven by using the driving unit 5 will be explained below. As described above, the light shielding plate 4 must implement the function of passing light passed through one of the bright field aperture 32 and dark field aperture 34 of the aperture stop 3, and shielding light passed through the other. Therefore, the size of the bright field aperture region 42a of the light shielding plate 4 is set larger than that of the bright field aperture 32 of the aperture stop 3, and the size of the dark field aperture region 44a of the light shielding plate 4 is set larger than that of the dark field aperture 34 of the aperture stop 3. Accordingly, the positioning accuracy required when driving the light shielding plate 4 can be set lower than that required when driving the aperture stop 1100 in the conventional illumination apparatus 1000. Therefore, even when the performance (the driving accuracy or stroke) of the driving unit 5 is lower than that of a driving unit to be used in the atmospheric environment, the driving unit 5 can position the light shielding plate 4 with the positioning accuracy required of the light shielding plate 4.

In this embodiment as described above, the aperture stop 3 including the plurality of apertures for defining the illumination condition is fixed (not driven), and the light shielding plate 4 including the aperture regions for passing light passed through one of the plurality of apertures is driven. Since this reduces a shift of the numerical aperture of light concentrated by the field lens L2, the illumination conditions can be switched without decreasing the illumination accuracy.

The positional relationship between the aperture stop 3 and light shielding plate 4 will now be explained. As described above, the aperture stop 3 is arranged (fixed) on the pupil plane of the illumination optical system 2, and the light shielding plate 4 is arranged near the aperture stop 3 and closer to the illumination surface than the aperture stop 3. The positions where the aperture stop 3 and light shielding plate 4 are arranged are different because the functions to be implemented by the aperture stop 3 and light shielding plate 4 when switching the illumination conditions are different. In this embodiment, the aperture stop 3 fixed on the pupil plane of the illumination optical system 2 passes light corresponding to bright field illumination and light corresponding to dark field illumination, and the light shielding plate 4 shields one of the light corresponding to the bright field illumination and the light corresponding to dark field illumination. If, for example, the aperture stop 3 is arranged in a position other than the pupil plane of the illumination optical system 2, the angular aperture of light passing through the aperture stop 3 cannot sufficiently be limited. This makes it impossible to guide the light corresponding to bright field illumination and the light corresponding to dark field illumination to the illumination surface IS. Accordingly, the aperture stop 3 must be arranged on the pupil plane of the illumination optical system 2 in order to limit the angular aperture.

On the other hand, the light shielding plate 4 need not be arranged on the pupil plane of the illumination optical system 2, provided that the light shielding plate 4 can shield one of the light corresponding to bright field illumination and the light corresponding to dark field illumination. For example, it is possible to arrange the light shielding plate 4 in a position shifted from the pupil plane of the illumination optical system 2 in the direction of the optical axis, and shield one of the light passed through the aperture stop 3 and corresponding to bright field illumination and the light passed through the aperture stop 3 and corresponding to dark field illumination.

Note that the shift amount of the position where the light shielding plate 4 is arranged from the pupil plane of the illumination optical system 2 is determined based on the sizes of the bright field aperture 32 and dark field aperture 34 of the aperture stop 3, the sizes of the bright field aperture region 42a and dark field aperture region 44a of the light shielding plate 4, and the numerical aperture of light. Let r1 be the outer diameter of the bight field aperture 32 of the aperture stop 3, r2 be the inner diameter of the dark field aperture 34 of the aperture stop 3, R1 be the outer diameter of the bright field aperture region 42a of the light shielding plate 4, and R2 be the inner diameter of the dark field aperture region 44a of the light shielding plate 4. Also, let 0 be the angle the light passed through the aperture stop 3 makes with the optical axis of the illumination optical system 2. In this case, a shift amount X of the position where the light shielding plate 4 is arranged from the pupil plane of the illumination optical system 2 must satisfy

X<(r2−R1)/2×tan θ (1)

X<(R2−r1)/2×tan θ (2)

When expressions (1) and (2) are met, the light shielding plate 4 can shield one of the light passed through the aperture stop 3 and corresponding to bright field illumination and the light passed through the aperture stop 3 and corresponding to dark field illumination, and pass the other.

Also, in the illumination apparatus 100, it is sometimes difficult to respectively arrange the aperture stop 3 and light shielding plate 4 on and near the pupil plane of the illumination optical system 2 due to, for example, the limitation on the installation space. In this case, the aperture stop 3 is arranged (fixed) on one of a plurality of pupil planes of the illumination optical system 2, and the light shielding plate 4 is arranged on or near another pupil plane. In the illumination apparatus 100, therefore, the aperture stop 3 is arranged on the pupil plane of the illumination optical system 2, and the light shielding plate 4 is arranged near the pupil plane of the illumination optical system 2 or in a position conjugate with (or near) the pupil plane.

In the illumination apparatus 100 of this embodiment as described above, the illumination conditions are switched by passing one of the light components passed through the bright field aperture 32 and dark field aperture 34 of the aperture stop 3, and shielding the other, by using the light shielding plate 4. In other words, the illumination conditions are switched by driving the light shielding plate 4 whose required positioning accuracy is lower than that of the aperture stop 3, without driving the aperture stop 3 requiring high positioning accuracy. Accordingly, even when using the driving unit 5 having performance lower than that of a driving unit to be used in the atmospheric environment, the illumination conditions can be switched without decreasing the illumination accuracy. In addition, the increase in cost can be suppressed because the driving unit 5 need not be so designed as to have the same performance as that of a driving unit to be used in the atmospheric environment.

Note that the light shielding plate 4 is placed closer to the illumination surface than the aperture stop 3 in this embodiment, but the light shielding plate 4 can also be placed closer to the light source than the aperture stop 3. When setting the illumination condition to bright field illumination in this case, the bright field aperture region 42a passes light reaching the bright field aperture 32 from among the light from the light source 1, and the light shielding region 42b shields light reaching the dark field aperture 34 from among the light from the light source 1. When setting the illumination condition to dark field illumination, the dark field aperture region 44a transmits light reaching the dark field aperture 34 from among the light from the light source 1, and the light shielding region 44b shields light reaching the bright field aperture 32 from among the light from the light source 1.

Furthermore, the light shielding plate 4 includes the bright field aperture region 42a and dark field aperture region 44a in the illumination apparatus 100 of this embodiment, but the present invention is not limited to this arrangement. For example, it is also possible to shield one of light passed through the aperture stop 3 and corresponding to bright field illumination and light passed through the aperture stop 3 and corresponding to dark field illumination, by using a light shielding plate having no aperture region.

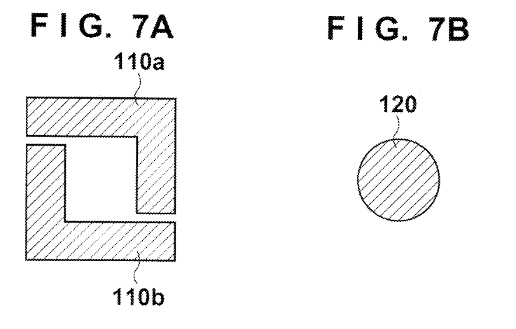

FIGS. 7A and 7B are views showing other arrangements of the light shielding plate 4. FIG. 7A shows an arrangement in which two light shielding plates (first light shielding plates) 110a and 110b having independent driving units (not shown) are used to transmit light reaching the bright field aperture 32 and shield light reaching the dark field aperture 34 from among the light from the light source 1. Consequently, bright field illumination can be implemented even in the arrangement in which the two light shielding plates 110a and 110b having no aperture region are driven instead of the bright field region 42 of the light shielding plate 4 shown in FIG. 1D.

FIG. 7B shows an arrangement in which a light shielding plate (second light shielding plate) 120 having no aperture region is used to transmit light reaching the dark field aperture 34 and shield light reaching the bright field aperture 32 from among the light from the light source 1. Consequently, dark field illumination can be implemented even in the arrangement in which the light shielding plate 120 having no aperture region is used instead of the dark field region 44 of the light shielding plate 4 shown in FIG. 1D. Note that it is of course also possible to similarly implement dark field illumination even in an arrangement using a light shielding plate obtained by forming, in a transmitting plate that transmits light, a light shielding region for shielding only light reaching the bright field aperture 32 from among the light from the light source 1.

As described above, the illumination conditions can be switched without driving the aperture stop 3 requiring high positioning accuracy, regardless of which light shielding plate is used.

### Second Embodiment

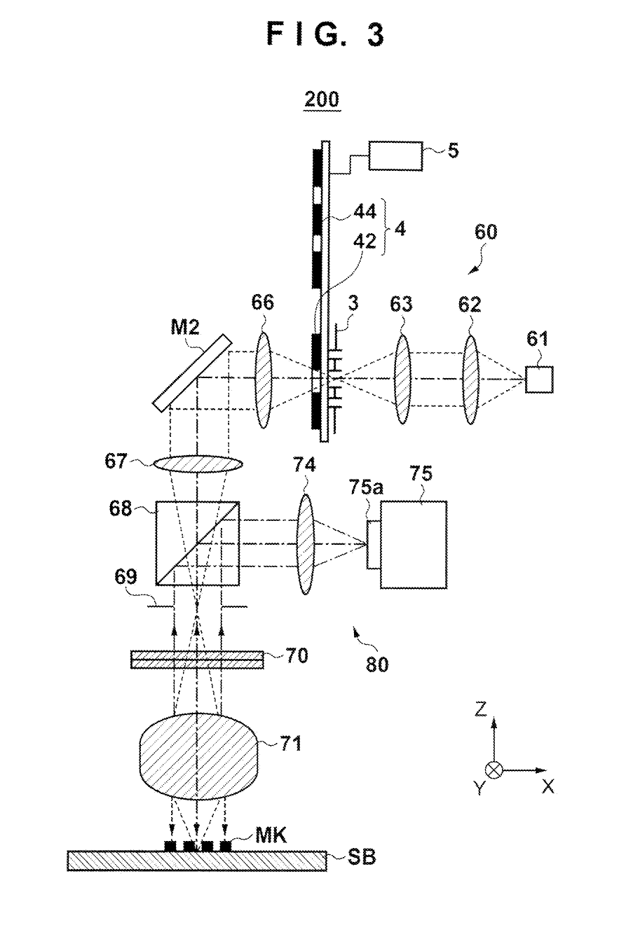

FIG. 3 is a view showing the arrangement of a position detection apparatus 200 as an aspect of the present invention. The position detection apparatus 200 includes an illumination optical system 60 for illuminating (marks MK formed on) a substrate SB with light from a light source 61, and an image formation optical system 80 for forming an image of light from the marks MK on a detection unit 75 (a detection surface 75a), and detects the position of the substrate SB (the marks MK) as an object.

The illumination optical system 60 includes an aperture stop 3, a light shielding plate 4, a driving unit 5, illumination lenses 62, 63, and 66, a mirror M2, a relay lens 67, a polarization beam splitter 68, a λ/4 plate 70, and an objective lens 71. The image formation optical system 80 includes an objective lens 71, the λ/4 plate 70, a detection aperture stop 69, the polarization beam splitter 68, and an image formation lens 74.

In the position detection apparatus 200, light from the light source 61 passes through the illumination lenses 62 and 63 and reaches the aperture stop 3 arranged in a position conjugate with the substrate SB. In this state, the light beam diameter of the aperture stop 3 is much smaller than that of the light source 61. The light passed through the aperture stop 3 is guided to the polarization beam splitter 68 through the light shielding plate 4, illumination lens 66, mirror M2, and relay lens 67. The polarization beam splitter 68 transmits P-polarized light parallel to the Y-axis direction, and reflects S-polarized light parallel to the X-axis. The P-polarized light transmitted through the polarization beam splitter 68 is guided to the λ/4 plate 70 through the detection aperture stop 69. The light converted into circularly polarized light through the λ/4 plate 70 passes through the objective lens 71, and illuminates the marks MK formed on the substrate SB by Koehler illumination.

The light reflected, diffracted, and scattered by the marks MK is converted from the circularly polarized light into S-polarized light through the objective lens 71 and λ/4 plate 70, and reaches the detection aperture stop 69 where the polarization state of the light from the marks MK is converted into circularly polarized light in the opposite direction to the circularly polarized light having illuminated the marks MK. In other words, when the polarization state of the light having illuminated the marks MK is clockwise circularly polarized light, the polarization state of the light from the marks MK is counterclockwise circularly polarized light. Also, the numerical aperture of the light from the marks MK can be controlled by changing the stopping amount of the detection aperture stop 69. The light passed through the detection aperture stop 69 is reflected by the polarization beam splitter 68, and guided to the detection unit 75 through the image formation lens 74. Consequently, images of the marks MK formed on the substrate SB are formed on the detection surface 75a of the detection unit 75.

In the position detection apparatus 200 of this embodiment, the light shielding plate 4 is used to pass one of the light components passed through a bright field aperture 32 and dark field aperture 34 of the aperture stop 3, and shield the other. For example, when a bright field region 42 of the light shielding plate 4 is positioned with respect to the aperture stop 3, the light shielding plate 4 passes the light passed through the bright field aperture 32 of the aperture stop 3, and shields the light passed through the dark field aperture 34 of the aperture stop 3. Therefore, the detection unit 75 can detect bright field images of the marks MK formed on the substrate SB. Also, when a dark field region 44 of the light shielding plate 4 is positioned with respect to the aperture stop 3, the light shielding plate 4 passes the light passed through the dark field aperture 34 of the aperture stop 3, and shields the light passed through the bright field aperture 32 of the aperture stop 3. Accordingly, the detection unit 75 can detect dark field images of the marks MK formed on the substrate SB.

In the position detection apparatus 200 of this embodiment as described above, the illumination conditions are switched by driving the light shielding plate 4 whose required positioning accuracy is lower than that of the aperture stop 3, without driving the aperture stop 3 requiring high positioning accuracy. Therefore, even when using the driving unit 5 having performance lower than that of a driving unit to be used in the atmospheric environment, the illumination conditions can be switched without decreasing the illumination accuracy, so the decrease in detection accuracy of the marks MK can be reduced. In other words, the position detection apparatus 200 can accurately detect the positions of the substrate SB and marks MK without decreasing the detection accuracy of the marks MK. It is also possible to suppress the increase in cost because the driving unit 5 need not be so designed as to have the same performance as that of a driving unit to be used in the atmospheric environment.

Note that the illumination optical system 60 includes the aperture stop 3, light shielding plate 4, and driving unit 5 in this embodiment, but the image formation optical system 80 may include these components. In this case, the light shielding plate 4 is used to pass one of the light components passed through the bright field aperture 32 and dark field aperture 34 of the aperture stop 3 and shield the other, thereby switching the detection conditions for detecting the light from the marks MK by the detection unit 75 (the detection surface 75a). In other words, the detection conditions can be switched by driving the light shielding plate 4 whose required positioning accuracy is lower than that of the aperture stop 3, without driving the aperture stop 3 requiring high positioning accuracy.

For example, when setting the detection condition to bright field detection, the driving unit 5 positions the bright field region 42 with respect to the aperture stop 3. More specifically, the driving unit 5 positions the bright field region 42 so that a bright field aperture region 42a does not shield a path extending from the marks MK to the detection surface 75a through the bright field aperture 32, and a light shielding region 42b shields a path extending from the marks MK to the detection surface 75a through the dark field aperture 34. Consequently, the detection unit 75 can detect bright field images of the marks MK formed on the substrate SB.

Also, when setting the detection condition to dark field detection, the driving unit 5 positions the dark field region 44 with respect to the aperture stop 3. More specifically, the driving unit 5 positions the dark field region 44 so that a dark field aperture region 44a does not shield the path extending from the marks MK to the detection surface 75a through the dark field aperture 34, and a light shielding region 44b shields the path extending from the marks MK to the detection surface 75a through the bright field aperture 32. Consequently, the detection unit 75 can detect dark field images of the marks MK formed on the substrate SB.

An exposure apparatus and drawing apparatus using the position detection apparatus 200 will be explained below.

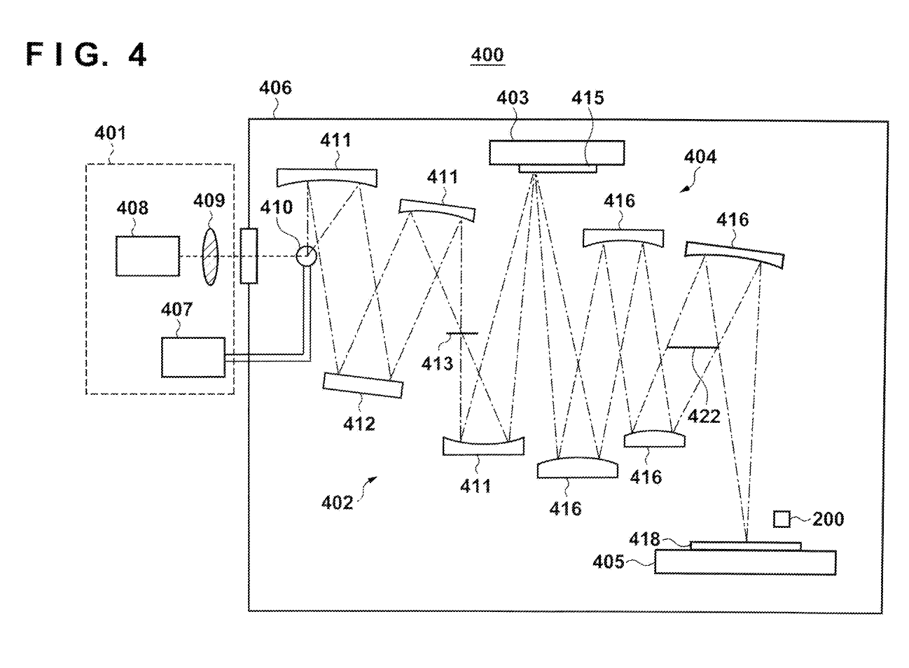

FIG. 4 is a view showing the arrangement of an exposure apparatus 400 using the position detection apparatus 200. The exposure apparatus 400 is a lithography apparatus for transferring a pattern of a reticle to a substrate (for example, a wafer) by using EUV (Extreme Ultra Violet) light having a wavelength of about 10 to 15 nm.

The exposure apparatus 400 includes a light source unit 401, illumination optical system 402, reticle stage 403, projection optical system 404, substrate stage 405, and vacuum chamber 406. The vacuum chamber 406 accommodates the illumination optical system 402, reticle stage 403, projection optical system 404, and substrate stage 405. The internal pressure of the vacuum chamber 406 is maintained at 10⁻⁴ to 10⁻⁵ Pa.

The light source unit 401 includes a target supply unit 407, excitation pulse laser radiation unit 408, and condenser lens 409. In the light source unit 401, a pulse laser from the excitation pulse laser radiation unit 408 is radiated through the condenser lens 409 to a target material supplied from the target supply unit 407 to the vacuum chamber 406, thereby generating a plasma 410 that radiates EUV light.

The illumination optical system 402 includes a plurality of mirrors 411 including a multilayered film mirror and oblique incident mirror, an optical integrator 412, and an aperture 413. The illumination optical system 402 concentrates the EUV light radiated from the plasma 410, and illuminates a reticle 415 held on the reticle stage 403.

The projection optical system 404 includes a plurality of mirrors 416 and an aperture 422, and projects the EUV light reflected by the reticle 415 onto a substrate 418 held on the substrate stage 405.

In the exposure apparatus 400, the position detection apparatus 200 can be applied to align the reticle 415 and substrate 418, and align a plurality of shot regions on the substrate 418. As described previously, the position detection apparatus 200 can accurately detect the position of the substrate 418 and the positions of the shot regions on the substrate 418. Therefore, the exposure apparatus 400 can accurately align the reticle 415 and substrate 418 and align the plurality of shot regions on the substrate 418, and hence can accurately transfer the pattern of the reticle 415 to the substrate 418.

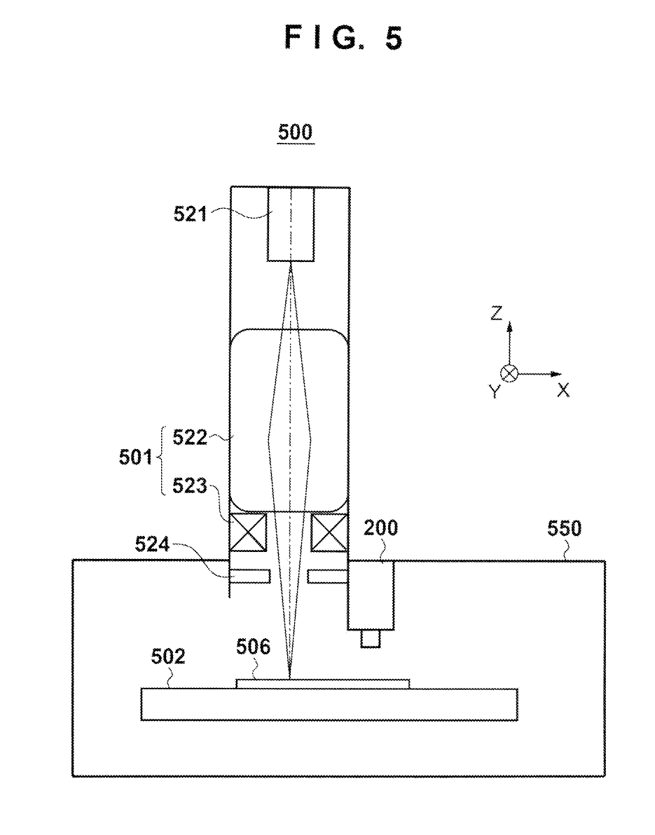

FIG. 5 is a view showing the arrangement of a drawing apparatus 500 using the position detection apparatus 200. The drawing apparatus 500 is a lithography apparatus for drawing a pattern on a substrate by using a charged particle beam (electron beam).

The drawing apparatus 500 includes an electron gun 521, a charged particle optical system 501, a detection system 524 for detecting a charged particle beam, a substrate stage 502 for holding a substrate 506, and a vacuum chamber 550. The vacuum chamber 550 accommodates the electron gun 521, charged particle optical system 501, detection system 524, and substrate stage 502. The charged particle optical system 501 includes a charged particle lens 522 for converging a charged particle beam from the electron gun 521, and a deflector 523 for deflecting the charged particle beam.

In the drawing apparatus 500, the position detection apparatus 200 is applicable to align the charged particle beam and substrate 506 and align a plurality of shot regions on the substrate 506. As described previously, the position detection apparatus 200 can accurately detect the position of the substrate 506 and the positions of the shot regions on the substrate 506. Accordingly, the drawing apparatus 500 can accurately align the charged particle beam and substrate 506 and align the plurality of shot regions on the substrate 506, and hence can accurately draw a pattern on the substrate 506.

### Third Embodiment

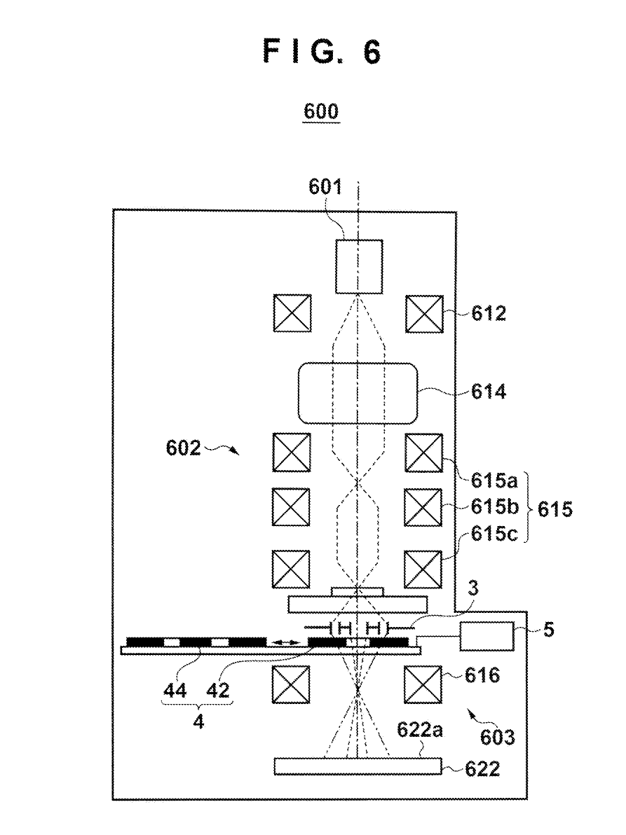

FIG. 6 is a view showing the arrangement of a microscope apparatus 600 as an aspect of the present invention. In this embodiment, the microscope apparatus 600 is embodied as a transmission electron microscope, and observes a sample 620 as an object. However, the microscope apparatus 600 is not limited to a transmission electron microscope, and applicable to any microscope for observing the sample 620 while switching the illumination conditions or detection conditions.

The microscope apparatus 600 includes an electron gun 601 for generating an electron beam, and a sample holder 621 holding the sample 620. The microscope apparatus 600 also includes an irradiation system 602 for irradiating the sample 620 with the electron beam from the electron gun 601, and a detection system 603 for guiding the electron beam transmitted through the sample 620 to a detection unit 622 (a detection surface 622a).

The irradiation system 602 includes a convergent lens 612, spherical aberration correcting lens 614, and transmission lens system (transfer lens system) 615. The transmission lens system 615 includes first, second, and third transmission lenses 615a, 615b, and 615c arranged along the optical axis of the irradiation system 602. The detection system 603 includes an aperture stop 3, a light shielding plate 4, a driving unit 5, an objective lens 616, and the detection unit 622. Since the electron beam from the electron gun 601 has high energy, the lenses in the irradiation system 602 and detection system 603 are preferably electromagnetic lenses. If the dielectric voltage is allowable, however, the lenses in the irradiation system 602 and detection system 603 may also be electrostatic lenses.

In the microscope apparatus 600, the electron beam from the electron gun 601 is converged on the sample 620 through the convergent lens 612, spherical aberration correcting lens 614, and transmission lens system 615. The electron beam transmitted through the sample 620 is detected by the detection unit 622 through the aperture stop 3, light shielding plate 4, and objective lens 616.

The observation of a bright field image and dark field image of the sample 620 in the microscope apparatus 600 will be explained below. In the microscope apparatus 600 of this embodiment, a portion of the electron beam (an electron beam corresponding to bright field detection or an electron beam corresponding to dark field detection) transmitted through the sample 620 is guided to the detection unit 622 by using the light shielding plate 4.

For example, when a bright field region 42 of the light shielding plate 4 is positioned with respect to the aperture stop 3, the light shielding plate 4 passes an electron beam passed through a bright field aperture 32 of the aperture stop 3, and shields an electron beam passed through a dark field aperture 34 of the aperture stop 3. Accordingly, the detection unit 622 detects an electron beam (non-scattered electron beam) transmitted through the sample 620, and an electron beam (inelastically scattered electron beam) having lost energy by colliding against the sample 620 and transmitted through it. This is so because the non-scattered electron beam and inelastically scattered electron beam are transmitted at a small scattering angle (generally about 10 mrad or less) corresponding to the incident angle (irradiation angle) to the sample 620. The detection unit 622 thus detects a bright field image of the sample 620.

Also, when a dark field region 44 of the light shielding plate 4 is positioned with respect to the aperture stop 3, the light shielding plate 4 passes light passed through the dark field aperture 34 of the aperture stop 3, and shields light passed through the bright field aperture 32 of the aperture stop 3. Therefore, the non-scattered electron beam and inelastically scattered electron beam are shielded, and the detection unit 622 detects an electron beam (elastically scattered electron beam) transmitted through the sample 620 without losing energy. This is so because the scattering angle of the elastically scattered electrons is larger than those of the non-scattered electron beam and inelastically scattered electron beam. Thus, the detection unit 622 detects a dark field image of the sample 620.

In the microscope apparatus 600 of this embodiment, the detection conditions when the detection unit 622 detects light transmitted through the sample 620 are switched by driving the light shielding plate 4 whose required positioning accuracy is lower than that of the aperture stop 3, without driving the aperture stop 3 requiring high positioning accuracy. Accordingly, even when using the driving unit 5 having performance lower than that of a driving unit to be used in the atmospheric environment, the detection conditions can be switched without decreasing the detection accuracy of the detection unit 622. This makes it possible to reduce the decrease in observation accuracy of the sample 620. In addition, the increase in cost can be suppressed because the driving unit 5 need not be so designed as to have the same performance as that of a driving unit to be used in the atmospheric environment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-237966 filed on Oct. 28, 2011, which is hereby incorporated by reference herein in its entirety.

What is claimed is:

1. An optical apparatus comprising:
an illumination optical system configured to illuminate an illumination surface with light from a light source;
an aperture stop including a first aperture configured to define an illumination condition for illuminating the illumination surface to a first condition, and a second aperture configured to define the illumination condition to a second condition different from the first condition, and fixed on a pupil plane of the illumination optical system;
a light shielding plate including a light shielding region; and
a driving unit configured to drive the light shielding plate,
wherein the driving unit positions the light shielding plate such that the light shielding region shields a second path extending from the light source to the illumination surface through the second aperture, when setting the illumination condition to the first condition, and
positions the light shielding plate such that the light shielding region shields a first path extending from the light source to the illumination surface through the first aperture, when setting the illumination condition to the second condition.

2. The apparatus according to claim 1, wherein
the light shielding plate includes a first light shielding region and a second light shielding region, and
the driving unit positions the light shielding plate such that the first light shielding region shields the second path, when setting the illumination condition to the first condition, and
positions the light shielding plate such that the second light shielding region shields the first path, when setting the illumination condition to the second condition.

3. The apparatus according to claim 2, wherein
the light shielding plate includes a first region including a first aperture region and the first light shielding region, and a second region including a second aperture region and the second light shielding region,
the light shielding plate is arranged closer to the illumination surface than the aperture stop,
the first aperture region passes light passed through the first aperture, and the first light shielding region shields light passed through the second aperture, when setting the illumination condition to the first condition, and
the second aperture region passes light passed through the second aperture, and the second light shielding region shields light passed through the first aperture, when setting the illumination condition to the second condition.

4. The apparatus according to claim 3, wherein
a size of the first aperture region is larger than that of the first aperture, and
a size of the second aperture region is larger than that of the second aperture.

5. The apparatus according to claim 2, wherein
the light shielding plate includes a first region including a first aperture region and the first light shielding region, and a second region including a second aperture region and the second light shielding region,
the light shielding plate is arranged closer to the light source than the aperture stop,
the first aperture region passes light reaching the first aperture from among light from the light source, and the first light shielding region shields light reaching the second aperture from among the light from the light source, when setting the illumination condition to the first condition, and
the second aperture region passes light reaching the second aperture from among light from the light source, and the second light shielding region shields light reaching the first aperture from among the light from the light source, when setting the illumination condition to the second condition.

6. The apparatus according to claim 5, wherein
a size of the first aperture region is larger than that of the first aperture, and
a size of the second aperture region is larger than that of the second aperture.

7. The apparatus according to claim 1, wherein
the light shielding plate includes a first light shielding plate having a first light shielding region, and a second light shielding plate having a second light shielding region, and
the driving unit positions the first light shielding plate such that the first light shielding region shields the second path, when setting the illumination condition to the first condition, and
positions the second light shielding plate such that the second light shielding region shields the first path, when setting the illumination condition to the second condition.

8. The apparatus according to claim 1, wherein the illumination optical system, the aperture stop, the light shielding plate, and the driving unit are arranged in a vacuum environment.

9. The apparatus according to claim 1, wherein
the first condition is bright field illumination, and
the second condition is dark field illumination.

10. A position detection apparatus which comprises an illumination optical system configured to illuminate an object with light from a light source, and an image formation optical system configured to form an image of light from the object on a detection surface, and detects a position of the object, wherein
the illumination optical system comprises:
an aperture stop including a first aperture configured to define an illumination condition for illuminating the object to a first condition, and a second aperture configured to define the illumination condition to a second condition different from the first condition, and fixed on a pupil plane of the illumination optical system;
a light shielding plate including a first region including a first aperture region and a first light shielding region, and a second region including a second aperture region and a second light shielding region; and
a driving unit configured to drive the light shielding plate, and
the driving unit positions the first region such that the first aperture region does not shield a first path extending from the light source to the object through the first aperture, and the first light shielding region shields a second path extending from the light source to the object through the second aperture, when setting the illumination condition to the first condition, and
positions the second region such that the second aperture region does not shield the second path, and the second light shielding region shields the first path, when setting the illumination condition to the second condition.

11. A position detection apparatus which comprises an illumination optical system configured to illuminate an object with light from a light source, and an image formation optical system configured to form an image of light from the object on a detection surface, and detects a position of the object, wherein
the image formation optical system comprises:
an aperture stop including a first aperture configured to define a detection condition for detecting light from the object on the detection surface to a first condition, and a second aperture configured to define the detection condition to a second condition different from the first condition, and fixed on a pupil plane of the image formation optical system;
a light shielding plate including a first region including a first aperture region and a first light shielding region, and a second region including a second aperture region and a second light shielding region; and
a driving unit configured to drive the light shielding plate, and
the driving unit positions the first region such that the first aperture region does not shield a first path extending from the object to the detection surface through the first aperture, and the first light shielding region shields a second path extending from the object to the detection surface through the second aperture, when setting the detection condition to the first condition, and
positions the second region such that the second aperture region does not shield the second path, and the second light shielding region shields the first path, when setting the detection condition to the second condition.

12. A microscope apparatus which comprises an irradiation system configured to irradiate an object with an electron beam, and a detection system configured to guide the electron beam transmitted through the object to a detection surface, and observes the object, wherein
the detection system comprises:
an aperture stop including a first aperture configured to define a detection condition for detecting the electron beam transmitted through the object on the detection surface to a first condition, and a second aperture configured to define the detection condition to a second condition different from the first condition, and fixed on a pupil plane of the detection system;
a light shielding plate including a first region including a first aperture region and a first light shielding region, and a second region including a second aperture region and a second light shielding region; and
a driving unit configured to drive the light shielding plate, and
the driving unit positions the first region such that the first aperture region does not shield a first path extending from the object to the detection surface through the first aperture, and the first light shielding region shields a second path extending from the object to the detection surface through the second aperture, when setting the detection condition to the first condition, and
positions the second region such that the second aperture region does not shield the second path, and the second light shielding region shields the first path, when setting the detection condition to the second condition.

13. An exposure apparatus for exposing a substrate, comprising:
a position detection apparatus configured to detect a position of a mark on the substrate as a position of an object; and
a positioning mechanism configured to position the substrate based on the position of the mark detected by the position detection apparatus,
wherein
the position detection apparatus which comprises an illumination optical system configured to illuminate the object with light from a light source, and an image formation optical system configured to form an image of light from the object on a detection surface, and detects a position of the object, wherein
the illumination optical system comprises:
an aperture stop including a first aperture configured to define an illumination condition for illuminating the object to a first condition, and a second aperture configured to define the illumination condition to a second condition different from the first condition, and fixed on a pupil plane of the illumination optical system;
a light shielding plate including a first region including a first aperture region and a first light shielding region, and a second region including a second aperture region and a second light shielding region; and
a driving unit configured to drive the light shielding plate, and
the driving unit positions the first region such that the first aperture region does not shield a first path extending from the light source to the object through the first aperture, and the first light shielding region shields a second path extending from the light source to the object through the second aperture, when setting the illumination condition to the first condition, and
positions the second region such that the second aperture region does not shield the second path, and the second light shielding region shields the first path, when setting the illumination condition to the second condition.
